(19) United States
(12) Patent Application Publication
(10) Pub. No.: US 2005/0275549 A1
(43) Pub. Date: Dec. 15, 2005

(54) Network support for emergency smoke detector/motion detector

(76) Inventors: Deborah Lewandowski Barclay, Winfield, IL (US); David S. Benco, Winfield, IL (US); Sanjeev Mahajan, Naperville, IL (US); Thomas Lee McRoberts, Naperville, IL (US); Raymond Leory Ruggerio, Glenview, IL (US)

Correspondence Address: PATTI & BRILL, ONE NORTH LASALLE STREET, 44TH FLOOR, CHICAGO, IL, 60602, US

(21) Appl. No.: 10/867,623

(22) Filed: Jun. 14, 2004

(51) Int. Cl. G08B 17/10

(52) U.S. Cl. 340/628; 340/540

(57) ABSTRACT

Embodiments of the apparatus, system, and method provide for the detection and location of people trapped in emergency situations. One embodiment of the apparatus may have: at least one detector having a predetermined location, the at least one detector structured to detect a respective predetermined event; a video camera operatively connected to the at least one detector; and a wireless communication device operatively connected to the at least one detector and to the video camera; wherein, upon detection of the predetermined event the detector activated the video camera and the wireless communication device to thereby transmit at least the occurrence of the predetermined event and video from the video camera.

### TECHNICAL FIELD

The present invention relates generally to detection of emergency situations, such as, a fire, and more particularly to a method and system that provides network support for the detection and location of people trapped, for example, in a smoke filled area, such as, a stairwell in a building, during a fire.

### BACKGROUND OF THE INVENTION

Fire alarm systems in large buildings normally comprise a plurality of sensors, such as heat sensors or smoke detectors, which are located at predetermined positions throughout the building. These sensors are connected to a central control panel, which typically is located in a control room or security office. Conventional control or mimic panels may include a LED display comprising a series of LEDs corresponding to respective sensors. When a particular sensor is activated, for example by detecting heat or smoke in its vicinity, its corresponding LED on the control panel lights up or flashes to signal that its associated sensor is in an alarm condition.

Environmental alarm systems such as fire, smoke, and passive infrared systems, for example, generally have a central controller connected to multiple sensing stations placed in strategic remote locations. In some passive systems the control panel simply gives an indication that something is wrong. In other addressable systems more specific information can be obtained by periodically polling the remote sensors.

Environmental sensors such as fire, smoke, and infrared detectors usually produce analog voltage or current output signals. The amount or density of detected smoke, the temperature sensed by a heat sensor, or sensor performance degradation can be conveyed by variations in the voltage or current of the output signal. When a system is addressable, the address of each sensor is a coded analog signal. This allows a message from a sensor to include information about a monitored environmental condition along with the location of a source of smoke, an unauthorized entry into a space, or other detected alarm-producing conditions, for example. The identification signal is usually a pattern of current pulses compliant with a protocol established by the design of the alarm system.

Unfortunately, these known systems are not capable of providing information to rescue personnel of the location and condition of people that may be trapped in a burning building, for example. Many times people are trapped in locked smoke filled stairwells during a fire, despite the presence of firefighters in the vicinity. It is well known that people have lost their lives because it was not possible to quickly find them during the fire. Thus there is a need to identify these types of emergence situations in real time and to accurately pinpoint the location of trapped individuals.

### SUMMARY

The invention in one implementation encompasses an apparatus. The apparatus may be for the detection and location of people trapped in emergency situations. One embodiment of the apparatus may have: at least one detector having a predetermined location, the at least one detector structured to detect a respective predetermined event; a video camera operatively connected to the at least one detector; and a wireless communication device operatively connected to the at least one detector and to the video camera; wherein, upon detection of the predetermined event the detector activates the video camera and the wireless communication device to thereby transmit at least the occurrence of the predetermined event and video from the video camera.

The invention in another implementation encompasses a system. One embodiment of the system may have: at least one apparatus having a unique apparatus identifier, the apparatus having at least one detector having a predetermined location, the at least one detector structured to detect a respective predetermined event, having a streaming video camera operatively connected to the at least one detector, and having a wireless communication device operatively connected to the at least one detector and to the streaming video camera; and a monitoring center wirelessly connected to the wireless communication device. Upon detection of the predetermined event, the detector activates the streaming video camera and the wireless communication device to thereby transmit at least the apparatus identifier, the occurrence of the predetermined event and streaming video from the streaming video camera to the monitoring center.

Another implementation of the present invention encompasses a method that may have the steps of: detecting, via at least one detector having a predetermined location, a respective predetermined event; taking, upon occurrence of the predetermined event, streaming video, via a streaming video camera, of a surveillance area of the streaming video camera; placing, upon occurrence of the predetermined event, a cellular call to an emergency number at a monitoring center; sending to the monitoring center at least the predetermined location of the detector, the streaming video, and data indicative of a detection of the predetermined event; wherein, upon detection of the predetermined event, the detector activates the streaming video camera and the wireless communication device to thereby transmit at least the apparatus identifier, the occurrence of the predetermined event and streaming video from the streaming video camera to the monitoring center.

### BRIEF DESCRIPTION OF THE DRAWINGS

Features of exemplary implementations of the invention will become apparent from the description, the claims, and the accompanying drawings in which:

FIG. 1 depicts a block diagram that illustrates elements of the apparatus, plus its use to monitor a surveillance area.

FIG. 2 illustrates a more detailed block diagram showing the FIG. 1 apparatus included in a network system, such that a communications connection can be made between the apparatus and a monitoring center.

FIG. 3 illustrates a very general flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

Embodiments of the present apparatus and method may provide for the detection and location of people trapped in emergency situations. Other emergency situations, as well as non-emergency situations, may be addressed by embodiments of the present apparatus and method.

One embodiment of the present apparatus, system and method provides an apparatus that combines a smoke detector and a streaming video camera with a preprogrammed mobile phone, such as a cell phone, to report the detection of smoke, for example, coupled with a live video feed of the affected area. The streaming video may or may not include audio. The detection of smoke triggers the device to connect to an emergency monitoring center and begin providing a live streaming video feed, allowing emergency personnel who arrive on the scene to accurately locate and assist people trapped, for example, in the building.

Streaming video is a sequence of “moving images” that are sent in compressed form over a network and displayed by the viewer as they arrive. Streaming media is streaming video with sound. With streaming video or streaming media, a user does not have to wait to download a large file before seeing the video or hearing the sound. Instead, the media is sent in a continuous stream and is played as it arrives. The user needs a player, which is a special program that uncompresses and sends video data to the display and audio data to speakers.

The detection and video apparatus may use an appropriate wireless data transmission method, such as IEEE 802.11, CDMA 3G-1X Data, CDMA 3G-EVDO, etc. to transmit, for example, the smoke detection event, and the streaming video. A GPS location device coupled with the apparatus may also be incorporated to provide accurate location information. Optionally, if the device is stationary/fixed, the location of the device or a device identifier may be configured within the device. If a device identifier is utilized, the emergency center may map the device identifier to the location of the device.

GPS stands for Global Positioning System. GPS was developed to allow the military to accurately determine their precise location anywhere in the world. GPS uses a collection of 24 satellites positioned in orbit to allow GPS equipment to automatically have its position triangulated to determine its location.

Although the present system and method may be used with any type of network (wired and wireless, for example), a subscriber may typically be a mobile subscriber who uses a mobile terminal (also referred to as mobile phone, a cell phone, mobile handset, or car phone).

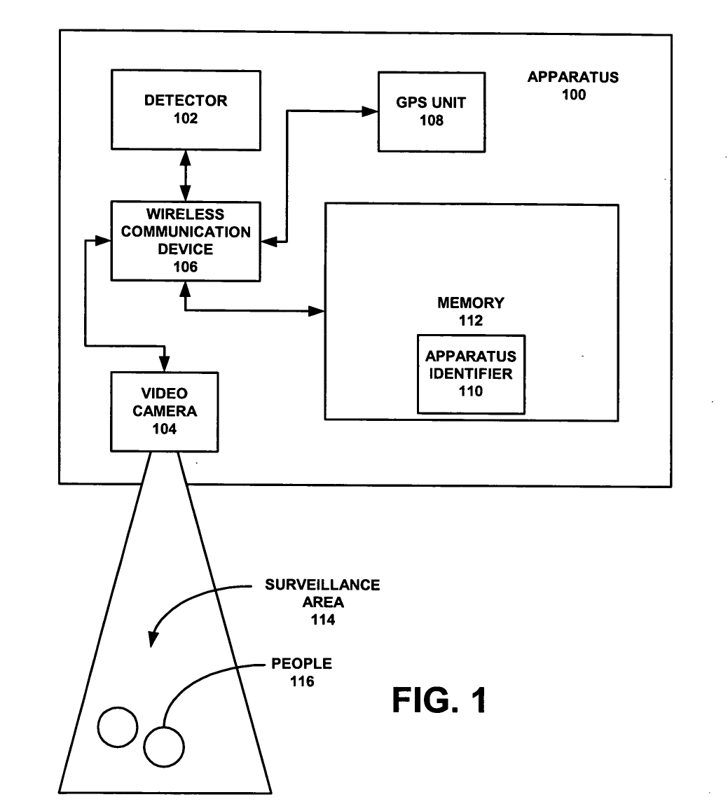

In the FIG. 1 embodiment the apparatus 100 may have at least one detector 102 having a predetermined location, the at least one detector 102 structured to detect a respective predetermined event; a video camera 104 operatively connected to the at least one detector 102; and a wireless communication device 106 operatively connected to the at least one detector 102 and to the video camera 104; wherein, upon detection of the predetermined event the detector 102 activates the video camera 104 and the wireless communication device 106 to thereby transmit at least the occurrence of the predetermined event and video from the video camera 106.

The detector 102 may be at least one of a smoke detector, a fire detector, and a motion detector, and wherein the predetermined event is smoke, heat, and motion, respectively. The video camera 104 may be a streaming video camera and the wireless communication device 106 may be a dedicated cell phone.

The apparatus 100 may further have a GPS unit 108 operatively connected to the wireless communication device 106, wherein, upon occurrence of the predetermined event, the wireless communication device 106 transmits location data, which is provided by the GPS unit 108, and wherein the location data is indicative of a location of the apparatus 100.

Furthermore, the apparatus 100 may have a unique apparatus identifier 110 that may be stored in a memory 112. Upon the occurrence of the predetermined event, the wireless communication device 106 transmits the apparatus identifier 110, which is indicative of a location of the apparatus 100 (for example, within a building having a plurality of such apparatus).

Typically, the video camera 104 has a surveillance area 114, and the video transmitted from the video camera 104 may be utilized to determine the presence of people 116 in the surveillance area 114 of the video camera 104. Also, the apparatus 100 may be structured to periodically transmit at least location data that is indicative of a location of the apparatus 100, a status of the detector 102, and a test video for verification of proper operation of the apparatus 100.

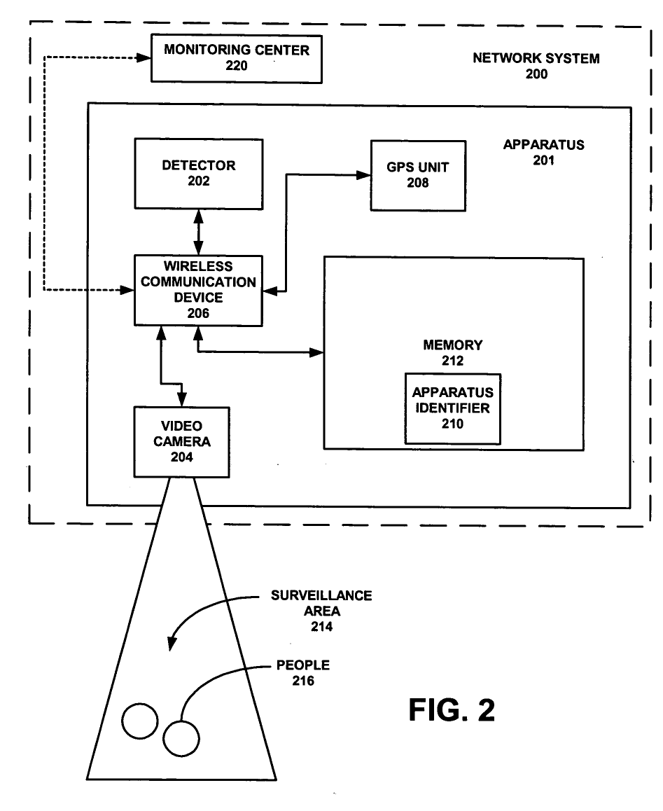

Referring to FIG. 2, a network system 200 is shown. One embodiment of the network system may have at least one apparatus 201 having a unique apparatus identifier 210 that may be stored in a memory 212, the apparatus 201 having at least one detector 202 having a predetermined location, the at least one detector 202 structured to detect a respective predetermined event, having a streaming video camera 204 operatively connected to the at least one detector 202, and having a wireless communication device 206 operatively connected to the at least one detector 202 and to the streaming video camera 204. The system 200 may also have a monitoring center 220 wirelessly connected to the wireless communication device 206. Upon detection of the predetermined event, the detector 202 activates the streaming video camera 204 and the wireless communication device 206 to thereby transmit at least the apparatus identifier 210, the occurrence of the predetermined event and streaming video from the streaming video camera 204 to the monitoring center 220.

The video camera 204 has a surveillance area 214 that is defined by the optics of the video camera 204. The surveillance area 214 in some embodiments is directional. In order to view various directions, the video camera 204 may be controllable from the monitoring center 220 to change the direction of the surveillance area 214. The video transmitted from the video camera 204 may be utilized to determine a presence of people 216 in the surveillance area 214 of the video camera 204.

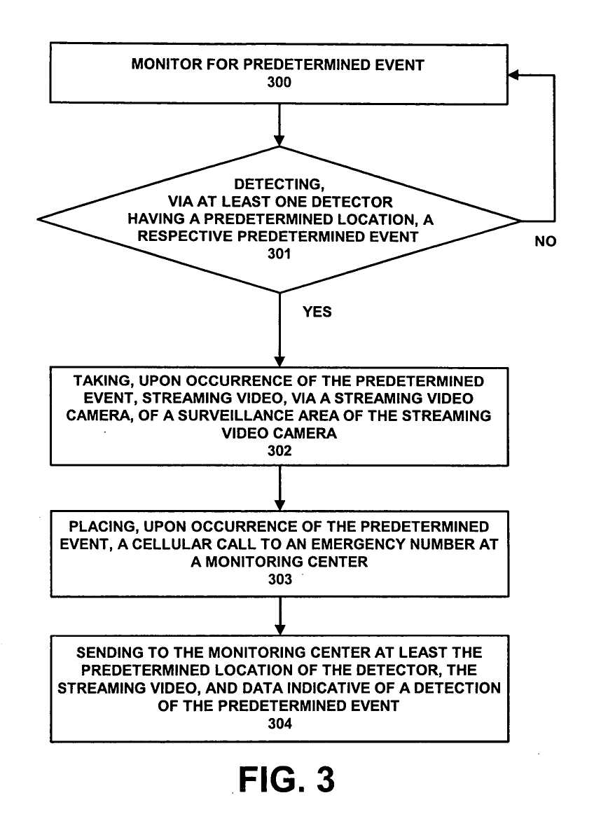

FIG. 3 is a block diagram depicting one embodiment of the present method. This embodiment of the method may have the steps of: monitoring for a predetermined event (step 300); detecting, via at least one detector having a predetermined location, a respective predetermined event (step 301); taking, upon occurrence of the predetermined event, streaming video, via a streaming video camera, of a surveillance area of the streaming video camera (step 302); placing, upon occurrence of the predetermined event, a cellular call to an emergency number at a monitoring center (step 303); sending to the monitoring center at least the predetermined location of the detector, the streaming video, and data indicative of a detection of the predetermined event (step 304); wherein, upon detection of the predetermined event, the detector activates the streaming video camera and the wireless communication device to thereby transmit at least the apparatus identifier, the occurrence of the predetermined event and streaming video from the streaming video camera to the monitoring center.

In further embodiments of the present method the detector may be at least one of a smoke detector, a fire detector, and a motion detector, and the predetermined event may be smoke, heat, and motion, respectively. Upon occurrence of the predetermined event, the method further include transmitting location data, which is provided by a GPS unit, to the monitoring center, the location data being indicative of a location of the apparatus.

The method may further have the steps of: controlling the streaming video camera from the monitoring center to change the surveillance area; and using the streaming video transmitted from the streaming video camera to determine a presence of people in the surveillance area of the video camera.

The method may also periodically transmit at least location data that is indicative of a location of the detector, a status of the detector, and a test video for verification of proper operation.

In other embodiments, when people are located in the surveillance area of the streaming video camera, the method may further have the step of at least one of transmitting current information derived from data received from the detector and the streaming video received from the streaming video camera to emergency personnel for assisting the people identified in the surveillance area.

Therefore, the improved present method and system overcomes the drawbacks of the prior art and provides an method and apparatus that combines a smoke detector and a streaming video camera with a preprogrammed mobile terminal, such as a cell phone, to report the detection of smoke, for example, coupled with a live video feed of the affected area.

The present system and method may be used with non-mobile phones and terminals, as well as, mobile phones and mobile terminals. Also, different types of data storage devices may be used with the present method and system. For example, a data storage device may be one or more of a magnetic, electrical, optical, biological, and atomic data storage medium.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
at least one detector having a predetermined location, the at least one detector structured to detect a respective predetermined event;
a video camera operatively connected to the at least one detector; and
a wireless communication device operatively connected to the at least one detector and to the video camera;
wherein, upon detection of the predetermined event the detector activates the video camera and the wireless communication device to thereby transmit at least the occurrence of the predetermined event and video from the video camera.

2. The apparatus according to claim 1, wherein the detector is at least one of a smoke detector, a fire detector, and a motion detector, and wherein the predetermined event is smoke, heat, and motion, respectively.

3. The apparatus according to claim 1, wherein the video camera is a streaming video camera.

4. The apparatus according to claim 1, wherein the wireless communication device is a dedicated cell phone.

5. The apparatus according to claim 1, wherein the apparatus further comprises a GPS unit operatively connected to the wireless communication device, wherein, upon occurrence of the predetermined event, the wireless communication device transmits location data, which is provided by the GPS unit, and wherein the location data is indicative of a location of the apparatus.

6. The apparatus according to claim 1, wherein the apparatus further comprises a unique apparatus identifier, and wherein, upon the occurrence of the predetermined event, the wireless communication device transmits the apparatus identifier, which is indicative of a location of the apparatus.

7. The apparatus according to claim 1, wherein the video camera has a surveillance area, and wherein the video transmitted from the video camera is utilized to determine the presence of people in the surveillance area of the video camera.

8. The apparatus according to claim 1, wherein the apparatus is structured to periodically transmit at least location data that is indicative of a location of the apparatus, a status of the detector, and a test video for verification of proper operation of the apparatus.

9. A network system, comprising:
at least one apparatus having a unique apparatus identifier, the apparatus having:
at least one detector having a predetermined location, the at least one detector structured to detect a respective predetermined event;
a streaming video camera operatively connected to the at least one detector;
a wireless communication device operatively connected to the at least one detector and to the streaming video camera; and
a monitoring center wirelessly connected to the wireless communication device;
wherein, upon detection of the predetermined event, the detector activates the streaming video camera and the wireless communication device to thereby transmit at least the apparatus identifier, the occurrence of the predetermined event and streaming video from the streaming video camera to the monitoring center.

10. The system according to claim 9, wherein the detector is at least one of a smoke detector, a fire detector, and a motion detector, and wherein the predetermined event is smoke, heat, and motion, respectively.

11. The system according to claim 9, wherein the wireless communication device is a dedicated cell phone.

12. The system according to claim 9, wherein the apparatus further comprises a GPS unit operatively connected to the wireless communication device, wherein, upon occurrence of the predetermined event, the wireless communication device transmits location data, which is provided by the GPS unit, to the monitoring center, and wherein the location data is indicative of a location of the apparatus.

13. The system according to claim 9, wherein the video camera has a surveillance area, wherein the video camera is controllable from the monitoring center to change the surveillance area, and wherein the video transmitted from the video camera is utilized to determine a presence of people in the surveillance area of the video camera.

14. The system according to claim 9, wherein the apparatus is structured to periodically transmit at least location data that is indicative of a location of the apparatus, a status of the detector, and a test video for verification of proper operation of the apparatus.

15. A method of monitoring predetermined areas, comprising the steps of:
detecting, via at least one detector having a predetermined location, a respective predetermined event;
taking, upon occurrence of the predetermined event, streaming video, via a streaming video camera, of a surveillance area of the streaming video camera;
placing, upon occurrence of the predetermined event, a cellular call to an emergency number at a monitoring center;
sending to the monitoring center at least the predetermined location of the detector, the streaming video, and data indicative of a detection of the predetermined event;
wherein, upon detection of the predetermined event, the detector activates the streaming video camera and the wireless communication device to thereby transmit at least the apparatus identifier, the occurrence of the predetermined event and streaming video from the streaming video camera to the monitoring center.

16. The method according to claim 15, wherein the detector is at least one of a smoke detector, a fire detector, and a motion detector, and wherein the predetermined event is smoke, heat, and motion, respectively.

17. The method according to claim 15, wherein, upon occurrence of the predetermined event, the method further comprises transmitting location data, which is provided by the GPS unit, to the monitoring center, and wherein the location data is indicative of a location of the apparatus.

18. The method according to claim 15, wherein the method further comprises:
controlling the streaming video camera from the monitoring center to change the surveillance area; and
using the streaming video transmitted from the streaming video camera to determine a presence of people in the surveillance area of the video camera.

19. The method according to claim 15, wherein the method further comprises periodically transmitting at least location data that is indicative of a location of the detector, a status of the detector, and a test video for verification of proper operation.

20. The method according to claim 15, wherein people are located in the surveillance area of the streaming video camera, wherein the method further comprises at least one of transmitting current information derived from data received from the detector and the streaming video received from the streaming video camera to emergency personnel for assisting the people identified in the surveillance area.
